(19) United States
(12) Patent Application Publication
(10) Pub. No.: US 2025/0315305 A1
(43) Pub. Date: Oct. 9, 2025

(54) EFFICIENT RESOURCE ALLOCATION

(71) Applicant: Arm Limited, Cambridge (GB)

(72) Inventors: Daren Croxford, Swaffham Prior (GB); Ozgur Tasdizen, Cambridge (GB); Mark Underwood, Cambridge (GB)

(21) Appl. No.: 18/627,240

(22) Filed: Apr. 4, 2024

(51) Int. Cl. G06F 9/50; G06F 9/48

(52) U.S. Cl. CPC G06F 9/5033; G06F 9/4881; G06F 2209/485; G06F 2209/5017

(57) ABSTRACT

The present disclosure relates to a graphics processor having a plurality of programmable execution units operable to process tasks of a first task type, a subset of the plurality of programmable execution units further operable to process tasks of a second task type, wherein the second task type is different to the first task type, and restricting a capacity of the subset of programmable execution units to process one or more tasks of a first task type when tasks of both the first task type and the second task type are to be allocated to the programmable execution units.

The present invention relates to methods, processors, and non-transitory computer-readable storage media for efficient resource allocation of different task types such as neural network processing operations, ray tracing operations, tiling operations, graphics processing operations, and so on.

In a graphics (image) processing context, neural network processing may also be used for image enhancement (de-noising), segmentation, anti-aliasing, supersampling, framerate upscaling, etc., in which case a suitable input image may be processed to provide a desired output image.

A neural network will typically process the input data (e.g. image data) according to a network of operators, each operator performing a particular operation. The operations will generally be performed sequentially to produce desired output data. Each operation may be referred to as a “layer” of neural network processing. Hence, neural network processing may comprise a sequence of “layers” of processing, such that the output from each layer is used as an input to a next layer of processing.

In some graphics data processing systems, a dedicated neural processing unit (NPU) is provided to perform neural processing, as a hardware accelerator that is operable to perform a specialised task such as the machine learning processing as and when desired, e.g. in response to an application that is executing on a host processor (e.g. central processing unit (CPU)) requiring the machine learning processing. Some graphics data processing systems may further include one or more other dedicated hardware accelerators to be operable to process one or more further specialised tasks, for example, dedicated units for one or more of tile processing (DBC Distributed Binning Core), ray tracing (RTU Ray Tracing Unit), MEE (Motion Estimation Engine), and so on. Similarly, a dedicated graphics processing unit (GPU) may be provided as a hardware accelerator that is operable to perform graphics processing. These dedicated hardware accelerators may be provided along the same interconnect (e.g. bus) alongside other components, such that the host processor is operable to request the hardware accelerators to perform a set of operations accordingly. The NPU, DBC, RTU, MEE, and GPU are, therefore, dedicated hardware units for performing operations such as machine learning processing operations and graphics processing operations on request by the host processor.

In some graphics processing systems, it has been recognized that, whilst not necessarily being designed or optimized for this purpose, a graphics processor, e.g. a graphics processing unit (GPU), may also be used (or re-purposed) to perform one or more of the specialised tasks, for example, machine learning processing tasks, DBC tasks, RTU tasks, MEE tasks and so on. For instance, convolutional neural network processing often involves a series of multiply-and-accumulate (MAC) operations for multiplying input feature values with the relevant feature weights of the kernel filters to determine the output feature values. Graphics processors typically include one or more programmable execution units (e.g. shader cores) executing shader programs which may be well-suited for performing these types of arithmetic operations, as these operations are generally similar to the arithmetic operations that may be required when performing graphics processing work (but on different data). Also, graphics processors typically support high levels of concurrent processing (e.g. supporting large numbers of execution threads) and are optimized for data-plane (rather than control plane) processing, all of which means that graphics processors may be well-suited for performing machine learning processing.

Thus, a graphics processor may be operated to perform machine learning processing work, in other words, incorporate a neural engine with each programmable execution unit (e.g. shader core). In that case, the graphics processor may be used to perform any suitable and desired machine learning processing tasks.

However, in conventional graphics processors, the programmable executions units (e.g. shader cores) are configurable on a global basis, such that all of the programmable execution units include a neural engine for performing neural network processing operations, e.g. machine learning processing operations, or none of the programmable execution units include a neural engine. Similarly, in relation of other specialised tasks such as RTU, DBC, MEE, and so on, as the programmable executions units (e.g. shader cores) are also configurable on a global basis, such that all of the programmable execution units include a RTU, DBC, MEE, and so on, for performing the respective specialised tasks, e.g. processing operations, or none of the programmable execution units include an RTU, DBC, MEE, and so on.

Conventional graphics processors typically include a plurality of programmable execution units (e.g. shader cores) and therefore, as the specialised tasks, such as machine learning processing operations (e.g. super sampling, frame rate upscaling, etc.), tile processing (DBC Distributed Binning Core), ray tracing (RTU Ray Tracing Unit), MEE (Motion Estimation Engine), and so on, are typically less frequent than standard graphics processing operations then it is inefficient to include the functionality to process each of the specialised tasks in each programmable execution unit (e.g. shader core), as this would increase the silicon area and power consumption of a device containing the graphics processing system, which is often limited in, for example, mobile devices.

The Applicants have recognised that there is a need for an improved and more efficient arrangement and resource allocation in graphics processing systems.

According to a first aspect of the present disclosure there is provided a graphics processor comprising: a plurality of programmable execution units operable to process tasks of a first task type; a subset of the plurality of programmable execution units further operable to process tasks of a second task type, wherein the second task type is different to the first task type; and one or more processing resources, wherein each processing resource is operable to obtain one or more commands, and to decompose each command of the one or more commands into one or more tasks of the first task type or the second task type to be allocated between the plurality of programmable execution units; wherein the processing resource is further operable to: determine the tasks to be allocated include both the first task type and the second task type; and based on the determination, restrict a capacity of one or more of the subset of programmable execution units to process tasks of the first task type.

In some embodiments, the processing resource may be further operable to obtain (or fetch) the one or more commands from a memory, wherein the commands may form one or more command streams that have been written to the memory by a host processor (e.g. a central processing unit (CPU)) and/or by a driver executing on, or operable connected to, the host processor. The processing resource may also be referred to as a command stream frontend.

Restricting a capacity of one or more of the subset of programmable execution units (e.g. shader cores) to process tasks of the first task type may refer to restricting an ability of the one or more of the subset of programmable execution units (e.g. shader cores) to process tasks of the first task type, or to enable one or more of the subset of programmable execution units (e.g. shader cores) to prioritise the processing of tasks of the second task type.

In some embodiments, the processing resource may further comprise, or may be operatively connected to, one or more iterators, and the processing resource may be further operable to: decompose each command into one or more jobs; and allocate each job to an iterator; wherein each iterator is operable to: decompose each job into the one or more tasks of a first task type or a second task type; and allocate each task between the plurality of programmable execution units.

In some embodiments, the processing resource may be further operable to: restrict the capacity of one or more of the subset of programmable execution units by allocating tasks of the first task type to programmable execution units that are not part of the subset of the programmable execution units; and allocating current tasks of the second task type to one or more of the subset of the programmable execution units.

In some embodiments, each programmable execution unit may include a queue, wherein the queue queues task(s) allocated to the programmable execution unit, and the processing resource may be further operable to: restrict the capacity of one or more of the subset of programmable execution units by reducing a queue limit for the queue associated with the one or more of the subset of programmable execution units.

In some embodiments, the processing resource may be further operable to reduce the queue limit by a value, wherein the value may be a static value or a dynamically determined value.

In some embodiments, the processing resource may be further operable to: restrict the capacity of one or more of the subset of programmable execution units by reserving a proportion of the one or more of the subset of programmable execution units for only processing tasks of the second task type.

In some embodiments, the processing resource may be further operable to: restrict the capacity of one or more of the subset of programmable execution units by reserving a proportion of a queue associated with the one or more of the subset of programmable execution units for queueing tasks of the second task type, wherein the queue queues tasks allocated to the associated one or more of the subset of programmable execution units.

In some embodiments, the processing resource may be further operable to: restrict the capacity of one or more of the subset of programmable execution units by not allocating further tasks, or further tasks of the first task type, to one or more of the subset of programmable execution units.

In some embodiments, the processing resource may be further operable to: restrict the capacity of one or more of the subset of programmable execution units by transmitting a cancellation message to cancel one or more tasks of the first task type from a queue associated with one or more of the subset of programmable execution units.

In some embodiments, the processing resource may be further operable to: determine whether a queue for one or more of the programmable execution units of the subset of programmable execution units exceeds a predetermined threshold of a number of tasks of the first task type; and if the determination indicates that the threshold is exceeded, transmit a cancellation request message to one or more of the programmable execution units that exceed the predetermined threshold.

In some embodiments, the processing resource may be further operable to: reallocate the cancelled task to another programmable execution unit.

In some embodiments, the processing resource may be further operable to: determine the tasks to be allocated include both the first task type and the second task type in advance of the task of the second task type being allocated to a programmable execution unit of the subset of programmable execution units.

In some embodiments, the processing resource may further comprise one or more scoreboards, wherein each scoreboard may track a progress of a producer process task, wherein the producer process task is associated with a consumer process task and provides, as output, the input to the consumer process task, and wherein the consumer process task may be a task of the second task type; the processing resource may be further operable to: monitor the one or more scoreboards to identify a consumer process task of the second task type awaiting a completion of the associated producer process task; and in advance of allocating the consumer process task of the second task type, restricting the capacity of one or more of the subset of programmable execution units to process tasks of the first task type.

In some embodiments, the scoreboard may include a counter for each producer process task and associated consumer process task, wherein the processing resource may be further operable to monitor for a counter of the producer process task associated with the consumer process task being non-zero.

In some embodiments, the processing resource may be further operable to: obtain one or more commands in advance of executing the one or more commands; analyse the commands in the obtained one or more commands to identify future tasks of the first task type and the second task type; and in advance of allocating the future tasks of the second task type, restricting the capacity of one or more of the subset of programmable execution units to process tasks of the first task type.

In some embodiments, the processing resource may be further operable to: restrict the capacity of one or more of the subset of programmable execution units by transmitting a suspend message to suspend one or more tasks of the first task type that are currently being processed by the one or more of the subset of programmable execution units.

In some embodiments, the processing resource may be further operable to: transmit a resume message to the one or more of the subset of programmable execution units to resume a task of the one or more tasks of the first task type that were suspended.

In some embodiments, the processing resource may be further operable to: restrict the capacity of one or more of the subset of programmable execution units by transmitting a message to instruct one or more of the subset of programmable execution units to not process one or more tasks of the first task type that are currently in a queue associated with the one or more of the subset of programmable execution units.

According to a second aspect of the present disclosure there is provided a method of operating a graphics processor, wherein the graphics processor comprises: a plurality of programmable execution units operable to process tasks of a first task type; a subset of the plurality of programmable execution units further operable to process tasks of a second task type, wherein the second task type is different to the first task type; and one or more processing resources; the method comprising: obtaining, by a processing resource, one or more commands; decomposing each command of the obtained one or more commands into one or more tasks of the first task type or the second task type to be allocated between the plurality of programmable execution units; determining the tasks to be allocated include both the first task type and the second task type; and restricting a capacity of one or more of the subset of programmable execution units to process tasks of the first task type.

In some embodiments, the method may further implement one or more features of the first aspect.

According to a third aspect of the present disclosure there is provided a data processing system comprising: a host processor, a memory; and one or more graphics processors according to any one of the graphics processors of the first aspect.

According to a fourth aspect of the present disclosure there is provided a non-transitory computer readable storage medium storing software code that when executing on a graphics processor performs a method of operating a graphics processor according to the first aspect.

It will be appreciated that any features described herein as being suitable for incorporation into one or more aspects or embodiments of the present disclosure are intended to be generalizable across any and all aspects and embodiments of the present disclosure. Other aspects of the present disclosure can be understood by those skilled in the art in light of the description, the claims, and the drawings of the present disclosure. The foregoing general description and the following detailed description are exemplary and explanatory only and are not restrictive of the claims.

Embodiments of the present disclosure will now be described, by way of example only, and with reference to the accompanying figures, in which:

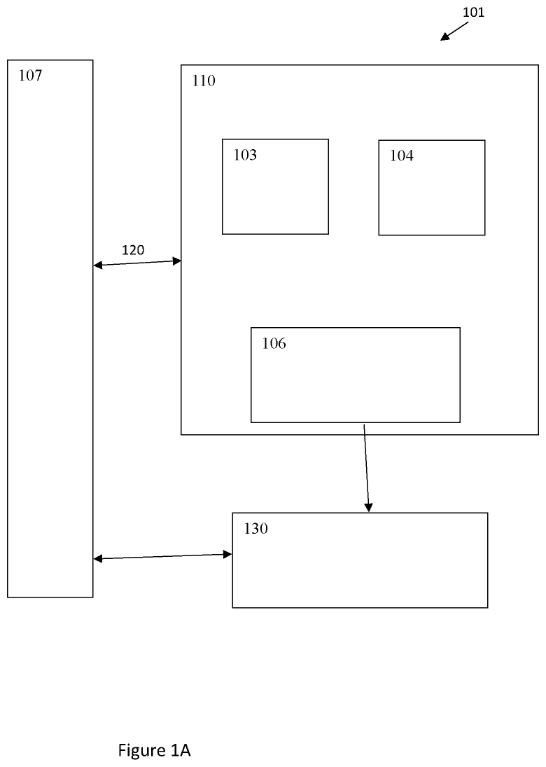

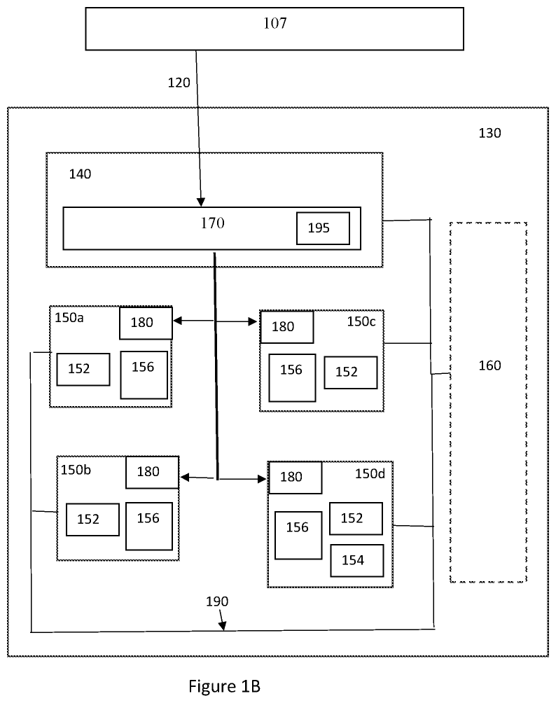

FIG. 1A is a schematic diagram of a data processing system according to one or more embodiments of the present disclosure.

FIG. 1B is a schematic diagram of a graphics processor according to one or more embodiments of the present disclosure.

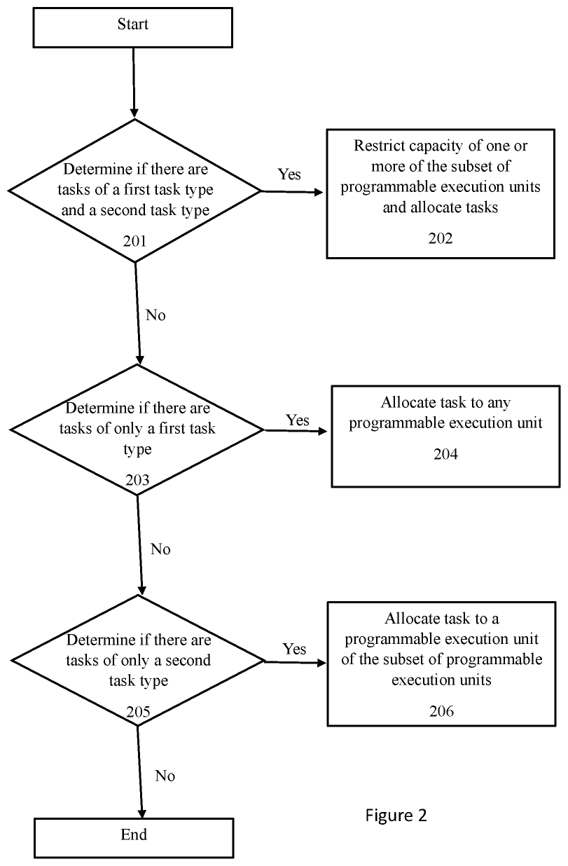

FIG. 2 is a flowchart of an arbitration method according to one or more embodiments of the present disclosure.

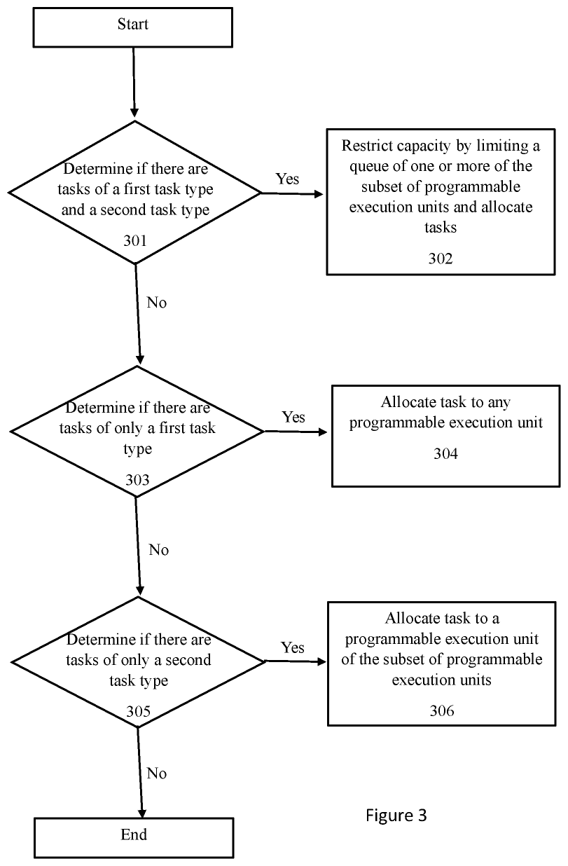

FIG. 3 is a flowchart of an arbitration method according to one or more embodiments of the present disclosure.

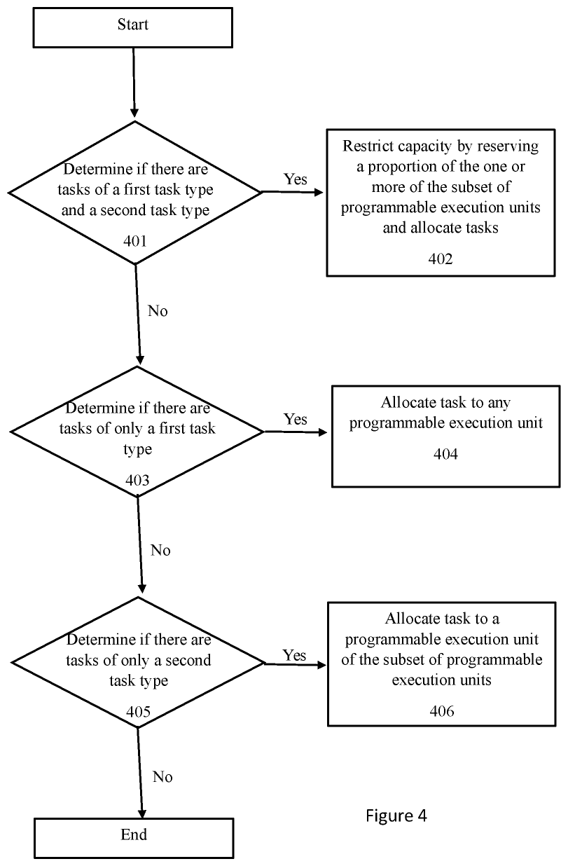

FIG. 4 is a flowchart of an arbitration method according to one or more embodiments of the present disclosure.

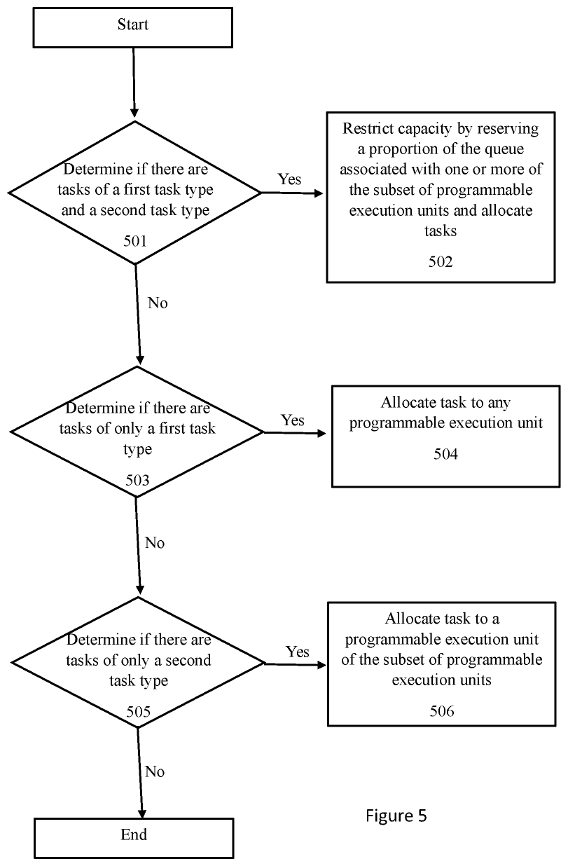

FIG. 5 is a flowchart of an arbitration method according to one or more embodiments of the present disclosure.

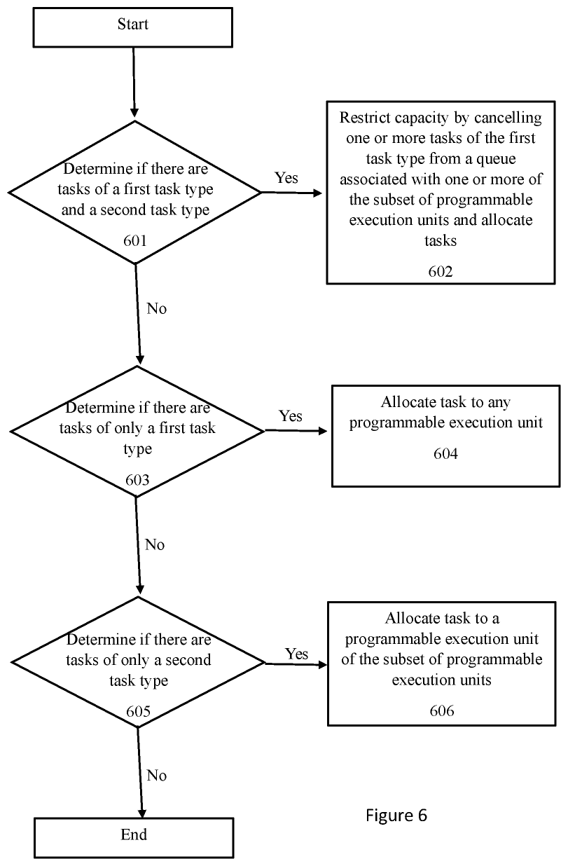

FIG. 6 is a flowchart of an arbitration method according to one or more embodiments of the present disclosure.

FIG. 1A shows a simplified schematic of a data processing system 101 that may include a host processor 110 on which an operating system (OS) 103, and one or more applications 104 may execute. The data processing system 101 may also include an associated graphics processor (which may also be referred to as a graphics processing unit (GPU)) 130 that can perform graphics processing operations for the applications 104 and the operating system 103 executing on the host processor 110. To facilitate this, the host processor 110 may also execute a driver 106 for the graphics processor 130. The application 104 may generate API (Application Programming Interface) calls that are interpreted by the driver 106 to generate appropriate commands for the graphics processor 130 to generate the graphics output required by the application 104.

The driver 106 may be operable to generate a set of “commands” (e.g. one or more commands) to be provided to the graphics processor 130 in response to requests from the application 104 running on the host processor 110. In embodiments, the appropriate commands and data for performing the processing tasks required by the application 104 may be provided to the graphics processor 130 in the form of one or more command stream(s) 120, that each include a sequence of commands (instructions) for causing the graphics processor 130 to perform desired processing tasks.

The one or more commands (e.g. command streams) 120 may be prepared by the driver 106 on the host processor 110 and may, for example, be stored in appropriate command (stream) buffers in system memory 107, from where they can then be obtained by (or read into, or fetched by), the graphics processor 130 for execution. The graphics processor may include a one or more processing resources (such as command stream frontends (CSF)) for obtaining (or receiving, or fetching), and interpreting these commands.

FIG. 1B, is a schematic diagram showing the graphics processor 130 in more detail. The graphics processor 130 provides dedicated circuitry, hardware resources, functional units, and so on, including, for example, programmable execution units (e.g. shader cores), memory, processing resources (command stream frontends), iterators, and so on, that can be used to perform various graphics data processing operations, as will be described hereinbelow.

The host processor, such as a central processing unit (CPU), may write one or more data structures, programs, and assets to a system memory 107, in particular, into one or more buffers of the system memory. As mentioned above, one of the data structures written to system memory 107 may include the one or more commands (or command streams) 120. The host processor may also configure the graphics processor 130 in preparation for processing one or more of the commands. Once the graphics processor has been configured by the host processor, the graphics processor 130 is arranged to obtain (e.g. read, or fetch), the commands (e.g. command stream(s)) 120, for example, from the system memory 107. In embodiments, each of the one or more commands include at least one command (instructions) in a given sequence, each command to be executed, and each command may be decomposed into a number of tasks. These tasks may be self-contained operations, such as a given machine learning operation or a graphics processing operation. It will be appreciated that there may be other types of tasks depending on the command, e.g. distributed binning tasks, motion estimation tasks, ray tracing tasks, and so on.

The command(s) 120 are obtained by the processing resource (e.g. command stream frontend) 140 of the graphics processor 130, for example, from system memory 107. The processing resource may include, or be operatively connected to, a Micro Controller Unit (MCU) wherein the MCU may execute, or run, firmware (FW) to communicate with the host processor and may program one or more control registers within the processing resource including, for example, one or more iterators. The FW may assign commands (or command streams) to iterators and may configure the iterators with information relating to enabled and operable programmable execution units (e.g. shader cores) for specific tasks and/or task types, making the programmable execution units usable by a particular iterator(s). The processing resource (such as a command stream frontend) 140, which may be implemented as a single (hardware) functional unit, is arranged to schedule the commands (for example, within a command stream) 120 in accordance with their sequence. The processing resource 140 may be arranged to schedule the commands and decompose each command into at least one job and assign each job to an appropriate iterator 170. In embodiments, the processing resource 140 includes, or is or operatively connected to, one or more iterator(s) 170 which split, or decompose the received job into a plurality of tasks and allocates, or distributes, the tasks between the programmable execution units (e.g. shader cores) 150a, 150b, 150c, 150d. The iterators and the programmable execution units may be connected by a bus, for example, a Job Control Network (JCN) over which the iterator can transmit messages (e.g. configuration and task messages) to the programmable execution units, and the programmable execution units can transmit task responses to the iterators.

A single iterator is shown in FIG. 1B, however, as will be appreciated, there may any number of iterators 170, for example, a tiler iterator, a fragment iterator, a computer iterator, a neural iterator, and so on. In embodiments, each programmable execution unit includes a queue 180 to which a task from the iterator can be allocated for processing by that programmable execution unit.

In the example shown in FIG. 1B, the graphics processor 130 comprises four programmable execution units (e.g. shader cores) 150a, 150b, 150c, 150d, however, as will be appreciated the graphics processor 130 may include any number of programmable execution units (e.g. shader cores), wherein each is operable to perform any number of tasks and handle one or more of the different task types.

Each programmable execution unit 150a, 150b, 150c, and 150d may be a shader core of a graphics processor specifically configured and operable to undertake one or more different types of operations, e.g., different task types. Each programmable execution unit (e.g. shader core) 150a, 150b, 150c, and 150d may comprise a number of components, including one or more of a first processing modules 152, for executing tasks of a first task type, and a second processing module 154, for executing tasks of a second task type, different from the first task type. As will be appreciated, any number of processing modules may be included in a programmable execution unit, each operable to process different task types. In embodiments, the first processing module 152 may be a processing module for processing task(s) relating to “standard” graphics processing operations forming a set of pre-defined graphics processing operations which enables the implementation of a graphics processing pipeline. For example, such “standard” graphics processing operations include one or more of a graphics compute shader task, a vertex shader task, a fragment shader takes, a tessellation shader task, a geometry shader task, a mesh shader task, and so on. It will be appreciated that any number of other graphics processing operations may be capable of being processed by the second processing module. Similarly, in embodiments, the second processing module 154 may be a processing module for processing task(s) relating to “specialised” operations, or “special” tasks, for example, neural processing operations, ray-tracing operations, tile distributed binning operations, motion estimation operations, and so on.

In the example shown in FIG. 1B, programmable execution units (e.g. shader core) 150a, 150b, and 150c include the first processing module 152, whilst programmable execution unit (e.g. shader core) 150d includes both the first processing module 152 and the second processing module 154, in other words, in this example, the programmable execution unit 150d includes a neural engine (NE) for processing machine learning operations, but as will be appreciated the programmable execution unit may include a ray-tracing unit (RTU), a tile binning core, such as a Distributed Binning Core (DBC), a Motion Estimation Engine (MEE), and so on.

In addition to comprising the first processing module 152 and/or the second processing module 154, each programmable execution unit (e.g. shader core) 150a, 150b, 150c, 150d, may also comprise a memory in the form of a local cache 156 for use by the respective processing module 152, 154 during the processing of tasks. Examples of such a local cache 156 is an L1 cache. The local cache 156 may, for example, be a static random-access memory (SRAM). It will be appreciated that the local cache 156 may comprise other types of memory.

The local cache 156 may be used for storing data relating to the tasks which are being processed on a given programmable execution unit (e.g. shader core) 150a, 150b, 150c, 150d by the first processing module 152 and/or the second processing module 154. In some examples it may be necessary to provide access to data associated with a given task executing on a processing module of a given programmable execution unit 150a, 150b, 150c, 150d to a task being executed on a processing module of another programmable execution unit 150a, 150b, 150c, 150d of the processor 130. In such examples, the processor 130 may also comprise a cache 160, such as an L2 cache for providing access to data use for the processing of tasks being executed on different programmable execution units 150a, 150b, 150c, 150d.

One or more of the processing resources140, the programmable execution units 150a, 150b, 150c, 150d, and the cache 160 may be interconnected using a bus 190. This allows data to be transferred between the various components. The bus may be or include any suitable interface or bus. For example, an ARM® Advanced Microcontroller Bus Architecture (AMBA) interface, such as the Advanced eXtensible Interface (AXI), may be used.

The arrangement shown in FIG. 1B is advantageous as only a subset of the programmable execution units (e.g. shader cores) are configured to be operable to process different task types, e.g. machine learning processing operations, thereby reducing the silicon area and power consumption, which is typically important in, for example, mobile devices. However, such an arrangement causes additional problems in terms of the allocation of the programmable execution units, dependencies (e.g. memory dependencies, region dependencies, and so on) and/or conflicts (e.g. resource conflicts, power conflicts, and so on), in relation to an efficient allocation of the programmable execution units (e.g. shader cores) of such an arrangement.

In terms of memory dependencies, one job, or one or more tasks associated with the job, may be dependent on one or more results of a processing operation relating to previous job or jobs, or another task or tasks associated with the job or the previous job. There may also be region dependency wherein the input for a current job or task may be dependent on the output of the previous job(s) or task(s). For example, if the current job processes an image generated by the previous job(s), then typically the processing of the current job would need to wait for the processing of the previous job(s) to be completed prior to processing the current job. If a job was decomposed into one or more tasks, then a first current task may process, for example, the top left portion of the image, and another second current task may process, for example, the top right portion of the image, and so on. It may be the case that the current frame task(s) for the top level portion of the image may only require data to be processed previously from the top left portion of the previous job/task. Therefore, the current first task (top left) may be able to proceed and be processed if the previous task relating to the top left of the image has been processed and completed.

In terms of resource conflicts, for the arrangement in which only a subset of the programmable execution units (e.g. shader cores) can perform one or more particular different task types, for example, machine learning operations, as shown in FIG. 1, then there may be a resource conflict. For example, there can be multiple tasks to be processed wherein the tasks include different task types and the subset of the programmable execution units may become blocked from processing task(s) relating to the “specialised” task type(s) by being allocated tasks that can be processed by any programmable execution unit.

Existing schemes for resolving the dependency and/or conflict issues based on all of the programmable execution units (e.g. shader cores) being operable to process all of the different task types have limitations and would not be suitable for the arrangement as shown in FIG. 1B, as will be discussed below.

In the following examples, the first task type is a graphics processing operation, in particular, a fragment operation, and the second task type is a neural operation.

In one existing static scheduling scheme if there are no memory dependencies/region dependencies, a subset of the plurality of programmable execution units can be configured to process only the first task type e.g. graphics processing operations, and the remaining programmable execution units configured to process only the second task type e.g. neural processing operations, even though in the conventional system all of the programmable execution units are able to process both the first task type and the second task type. However, as shown in the following table, such an existing scheme would be inefficient for the new arrangement shown in FIG. 1 as effectively resources (e.g. programmable execution units) are reserved for processing only one task type.

| | “task | | | | |
|---|---|---|---|---|---|
| Command | cycle” | 150a | 150b | 150c | 150d |
| RUN_{—} | 1 | <AVAIL> | <AVAIL> | <AVAIL> | R_N_0 |
| NEURALx4 | | | | | |
| RUN_{—} | 2 | R_F_0 | R_F_1 | R_F_2 | R_N_1 |
| FRAGx12 | | | | | |
| | 3 | R_F_3 | R_F_4 | R_F_5 | R_N_2 |
| | 4 | R_F_6 | R_F_7 | R_F_8 | R_N_3 |
| | 5 | R_F_9 | R_F_10 | R_F_11 | <IDLE> |
| | 6 | R_F_12 | <AVAIL> | <AVAIL> | <IDLE> |

A further existing scheme allocates tasks to any programmable execution unit that is operable to process the task. Therefore, in the arrangement of the present disclosure where all programmable execution units (e.g. shader cores) are operable to process the first task type, e.g. graphics processing operations, and only a subset of programmable execution units (e.g. shader cores) are operable to process the second task type, e.g. neural operations, the subset of programmable execution units may become blocked by tasks of the first task type before those subset of programmable execution units can process tasks of the second task type. Such an existing scheme is therefore inefficient as the limited resources that are operable to process the second type of tasks, e.g. the subset of programmable execution units, can be blocked by a queue of tasks associated with the first type of task, as shown in the table below.

| | “task | | | | |
|---|---|---|---|---|---|
| Command | cycle” | 150a | 150b | 150c | 150d |
| RUN_{—} | 1 | R_F_0 | R_F_1 | R_F_2 | R_F_3 |
| FRAGx12 | | | | | |
| | 2 | R_F_4 | R_F_5 | R_F_6 | R_F_7 |
| | 3 | R_F_8 | R_F_9 | R_F_10 | R_F_11 |
| RUN_{—} | 4 | <AVAIL> | <AVAIL> | <AVAIL> | R_N_0 |
| NEURALx4 | | | | | |
| | 5 | <AVAIL> | <AVAIL> | <AVAIL> | R_N_1 |
| | 6 | <AVAIL> | <AVAIL> | <AVAIL> | R_N_2 |
| | 7 | <AVAIL> | <AVAIL> | <AVAIL> | R_N_3 |

In a further existing scheme, programmable execution units that are operable to process the second task type, e.g. neural operations, can be configured to not accept any tasks relating to the first task type, e.g. graphics processing operations. Such a static reservation of resources is inefficient as the programmable execution unit that is capable of processing both the first task type and second task type is prevented from processing tasks of the first task type, even though tasks of the first task type is likely to be the majority of the tasks to be processed. This is shown in the following table.

| | “task | | | | |
|---|---|---|---|---|---|
| Command | cycle” | 150a | 150b | 150c | 150d |
| RUN_{—} | 1 | R_F_0 | R_F_1 | R_F_2 | <IDLE> |
| FRAGx12 | | | | | |
| RUN_{—} | 2 | R_F_3 | R_F_4 | R_F_5 | R_N_0 |
| NEURALx4 | | | | | |
| | 3 | R_F_6 | R_F_7 | R_F_8 | R_N_1 |
| | 4 | R_F_9 | R_F_10 | R_F_11 | R_N_2 |
| | 5 | <AVAIL> | <AVAIL> | <AVAIL> | R_N_3 |

Accordingly, the existing schemes for allocating resources would be inefficient in respect of the arrangement of the present technique, for example, that shown in FIG. 1B. In particular, the existing schemes would further result in a poor utilisation of the available programmable execution units (e.g. shader cores), a lower throughput/framerate, and a longer (frame) latency.

Therefore, the Applicants have recognised the need for an improved and more efficient scheme for allocating commands, and the associated tasks of different task types, to the programmable execution units (e.g. shader cores) where only a subset of the plurality of programmable execution units are operable to process one or more different task types compared to the remaining programmable execution units. In embodiments, the allocation scheme to be implemented is an improved arbitration scheme for the efficient allocation of resources in a graphics processor.

In embodiments, the programmable execution units (e.g. shader cores) can be dynamically allocated in order to utilise the resources in an efficient and effective manner.

In embodiments, when there are tasks relating to only one task type (e.g. a first task type or a second task type) to be allocated, the iterator may allocate, or distribute, the task(s) to the queue for any of the programmable execution unit that is operable to process tasks of the single task type. For example, if the task to be allocated by the iterator is of the first task type, e.g. a “standard” graphics processing task, then the iterator may allocate the task to any of the programmable execution units (e.g. to any of 150a, 150b,150c and 150d in the example of FIG. 1). Similarly, if the task to be task to be allocated by the iterator is of the second task type, e.g. a neural processing task, then the iterator may allocate, or distribute, the task to any of the programmable execution units that is operable to process tasks of the second task type (e.g. to 150d in the example of FIG. 1).

However, if there are tasks relating to both different task types then, in embodiments, the processing resource (dynamically) restricts the capacity of one or more of the subset of programmable execution units (that are operable to process both the first task type and the second task type) to process task(s) of the first type of task. In other words, the processing resource can (dynamically) reduce the number of tasks of the first task type, e.g. the standard graphics processing operations, for one or more of the subset of programmable execution units which can process both the first and second task types to enable the one or more programmable execution units of the subset of programmable execution units to process, or prioritise, the task(s) of the second task type.

Various embodiments will now be described, with reference to FIGS. 2 to 6. For ease of description the various arbitration methods are described separately, however, as will be appreciated the arbitration methods described in relation to FIGS. 2 to 6 can be, and in embodiments are, combinable.

FIG. 2 shows a flowchart of an arbitration scheme according to one or more embodiments. In step 201, the processing resource is operable to determine if there are task(s) of both the first task type and the second task type to be executed, or processed. The arbitration method of the example shown in FIG. 2 may additionally perform a “lookahead” wherein in step 201 the processing resource is additionally operable to determine, or identify, if there are tasks of both the first task type and the second task type to be executed in the (near) future, e.g. in advance. Lookahead schemes are described in more detail further below.

If the determination at step 201 is “Yes”, the processing resource restricts the capacity of one or more of the subset of programmable execution units to process tasks of the first task type by allocating the task(s) of the first task type to programmable execution units that are not part of the subset of the programmable execution units, and allocating current task(s) of the second task type to one or more of the subset of the programmable execution units, in step 202, or subsequently allocating future task(s) of the second task type to one or more of the subset of the programmable execution units once they are available to be allocated and executed.

If the determination at step 201 is “No”, the processing resource determines if there are any task(s) of the first task type in step 203 and, if so, in step 204 the processing resource allocates the task(s) of the first task type to any one or more of the programmable execution units. If the processing resource determines in step 203 that there are no task(s) of the first task type, the processing resource determines if there are any task(s) of the second task type in step 205 and, if so, in step 206 the processing resource allocates the task(s) of the second task type to one or more of the subset of programmable execution units.

In embodiments, the arbitration scheme may alternatively, or additionally, be operable to restrict the capacity of one or more of the subset of programmable execution units by reducing a queue limit of the queue associated with the one or more of the subset of programmable execution units in relation to tasks of the first task type by a value, wherein the value may be predetermined (e.g. a static value that is preprogrammed) or (dynamically) determined based on one or more parameters, including, for example, a determination, or identification, of current or future task(s) of the second task type, the number of tasks of the first task type, the number of tasks of the second task type, and the number of the subset of programmable execution unit that are enabled, e.g. powered up.

For example, based on one or more of a complexity (e.g. an amount of processing required for the current and/or future task(s)), along with the number of tasks. a determination, or calculation, of a duration of time each task would require to be completed can be made, the number of programmable execution units in the graphics processor, the number of programmable execution units that are enabled (e.g. powered up), and number of task(s) presently in the queues, a dynamic value for the queue limit may be determined. Thus, the queue of each programmable execution unit is loaded with tasks of the first task type, and it is determined, or identified, that one or more tasks of the second task type are incoming, then a determination, or calculation, of the complexity for those tasks of the second task type can be made and the value for the queue limit dynamically determined. For example, if there are 8 programmable execution units and 4 programmable execution units are configured in the subset of programmable execution units, (i.e. are operable to execute, or process, tasks of the second task type), and it is determined that there will be only 2 tasks of the second task type currently, or in the (near) future, then prior to executing, or processing, the 2 tasks of the second task type, the queues of two of the subset of programmable execution units can be limited in respect of tasks of the first task type, wherein the limit value may be static or dynamic, that is the queue limit value may decrease (e.g. impose a greater restriction on capacity for the tasks of the first task type) during the time period prior to the allocation of the tasks of the second task type to the selected programmable execution units of the subset of programmable execution units.

By reducing the queue limit of one or more of the subset of programmable execution units in relation to tasks of the first task type, the processing resource, in particular, the iterator, will allocate the tasks of the first task type to the remaining programmable execution units, thereby utilising the remaining programmable execution units for task(s) of the first task type and enabling the one or more of the subset of programmable execution units to process task(s) of the second task type more efficiently (e.g. more rapidly). In other words, by reducing the queue limit of one or more of the subset of programmable execution units in relation to tasks of the first task type, it enables the queue depth of the one or more of the subset of programmable execution units to “drain” more quickly in respect of any tasks of the first task type, freeing up the queue of the one or more of the subset of programmable execution units to be allocated and execute tasks of the second task type in an efficient manner with reduced latency.

Alternatively, or additionally to reducing the queue limit the processing resource may reduce a task size where a smaller number of first type of tasks are queued in a queue associated with the one or more subset of programmable execution units. This enables the queue associated with the one or more subset of programmable execution units to be drained of task(s) relating to the first task type more quickly, thereby enabling task(s) of the second type of tasks to commence processing more quickly. Alternatively, or additionally, the same queue limit for the first type of tasks in a queue associated with the one or more subset of programmable execution units may be maintained, but the size of first type of task may be decreased to enable task(s) relating to the first task type more quickly to again be drained more quickly from a queue associated with the one or more subset of programmable execution units. For example, in the case of first task type being a compute task, rather than reducing the task queue limit from 16 to 4 (where each task may, for example, execute 512 threads), 16 tasks may still be queued while reducing the thread count of a task to, for example, 128 rather than 512. Similarly, for a fragment task, the corresponding adjustment could involve issuing a smaller tile size, such as opting for a 32×32 tile instead of a 64×64 tile (this way a fragment task will correspond to a smaller region in the rendered frame and can therefore drain more quickly from a queue associated with the one or more subset of programmable execution units).

FIG. 3 shows a flowchart of an arbitration scheme according to one or more embodiments, that implements the restriction in capacity via limiting one or more queues of one or more programmable execution units of the subset of programmable execution units. In step 301, the processing resource is operable to determine if there are task(s) of both the first task type and the second task type to be executed, or processed. The arbitration method of the example shown in FIG. 3 may additionally perform a “lookahead” wherein in step 301 the processing resource is additionally operable to determine, or identify, if there are tasks of both the first task type and the second task type to be executed in the (near) future. Lookahead schemes are described in more detail further below.

If the determination at step 301 is “Yes”, the processing resource, in step 302, restricts the capacity of one or more of the subset of programmable execution units to process tasks of the first task type by limiting a queue (either statically or dynamically) of one or more of the subset of programmable execution units in respect of the allocation of task(s) of the first task type to the one or more programmable execution units of the subset of the programmable execution units. Thus, in step 302, tasks of the first task type are more likely to be allocated to other of the programmable execution units that are not queue limited thereby enabling the allocation of current task(s) of the second task type to one or more of the subset of the programmable execution units, or subsequent future task(s) of the second task type, to the programmable execution units of the subset of the programmable execution units that have been queue limited.

If the determination at step 301 is “No”, the processing resource determines if there are any task(s) of the first task type in step 303 and, if so, in step 304 the processing resource allocates the task(s) of the first task type to any one or more of the programmable execution units. If the processing resource determines in step 303 that there are no task(s) of the first task type, the processing resource determines if there are any task(s) of the second task type in step 305 and, if so, in step 306 the processing resource allocates the task(s) of the second task type to one or more of the subset of programmable execution units.

Alternatively, or additionally, in embodiments the restriction of the capacity of one or more of the subset of programmable execution units may be implemented by a (programmable) reservation in which a proportion of the one or more of the subset of programmable execution units is reserved for only processing task(s) of the second task type when tasks of both the first task type and the second task type, either currently or in the (near) future (e.g. via a lookahead), are to be executed, or processed. In other words, a proportion of the available subset of programmable execution units can be reserved specifically to process task(s) of the second task type and the remaining programmable execution units of the subset of programmable execution units can be available to process task(s) of the first task type and the second task type. For example, if the graphics processing unit included a subset of 8 programmable execution units then a proportion of, for example, a quarter of the subset, i.e. 2 programmable execution units, can be reserved specifically to process only task(s) of the second task type. The remaining three quarters of the subset, e.g. 6 programmable execution units, remain available to process task(s) of the first task type and task(s) of the second task type. The proportion of the subset of programmable execution units to be reserved may be a set proportion, or a dynamic proportion that can vary depending on the need, e.g. the number of tasks of the second task type at a given time, or in the (near) future. For example, if using a lookahead to determine, or identify, that task(s) of the second task type are to be executed, or processed, in the (near) future, it can be determined the number of tasks of the second task type and an appropriate number of the subset of programmable execution units can be reserved based on the determination.

FIG. 4 shows a flowchart of an arbitration scheme according to one or more embodiments, that implements the restriction in capacity by reserving a proportion of the one or more of the subset of programmable execution units for only processing task(s) of the second task type when tasks of both the first task type and the second task type, either currently or in the (near) future (e.g. via a lookahead), are to be executed, or processed.

In step 401, the processing resource is operable to determine if there are task(s) of both the first task type and the second task type to be executed, or processed. The arbitration method of the example shown in FIG. 4 may additionally perform a “lookahead” wherein in step 401 the processing resource is additionally operable to determine, or identify, if there are tasks of both the first task type and the second task type to be executed in the (near) future. Lookahead schemes are described in more detail further below.

If the determination at step 401 is “Yes”, the processing resource, in step 402, restricts the capacity of one or more of the subset of programmable execution units to process tasks of the first task type by reserving a proportion of the one or more of the subset of programmable execution units for only processing task(s) of the second task type. Thus, in step 402, tasks of the first task type are allocated to programmable execution units that are not reserved for tasks of the second task type, enabling the allocation of current task(s) of the second task type, or subsequent future task(s) of the second task type, to one or more of the reserved programmable execution units of the subset of the programmable execution units.

If the determination at step 401 is “No”, the processing resource determines if there are any task(s) of the first task type in step 403 and, if so, in step 404 the processing resource allocates the task(s) of the first task type to any one or more of the programmable execution units. If the processing resource determines in step 403 that there are no task(s) of the first task type, the processing resource determines if there are any task(s) of the second task type in step 405 and, if so, in step 406 the processing resource allocates the task(s) of the second task type to one or more of the subset of programmable execution units.

In the above example of FIG. 4, a proportion of the subset of programmable execution units was reserved to execute, or process, tasks of the second task type. However, as will be appreciated, alternatively or additionally, a proportion of the subset of programmable execution units was reserved to execute, or process, tasks of the first task type and/or a proportion of the programmable execution units that are not part of the subset of programmable execution units can be reserved to execute, or process, tasks of the first task type.

Similarly, in embodiments the restriction of the capacity of one or more of the subset of programmable execution units may, additionally or alternatively, be implemented by a (programmable) reservation in which a proportion of a queue associated with one or more of the subset of programmable execution units is reserved for queueing task(s) of the second task type. For example, if the queue for a given programmable execution unit of the subset of programmable execution unit can include up to 16 tasks, then a proportion of, for example, a quarter, e.g. 4, of the total number of tasks that can be allocated to the programmable execution unit can be reserved specifically to process only task(s) of the second task type.

FIG. 5 shows a flowchart of an arbitration scheme according to one or more embodiments, that implements the restriction in capacity by reserving a proportion of the queue associated with one or more of the subset of programmable execution units for queueing task(s) of the second task type.

In step 501, the processing resource is operable to determine if there are task(s) of both the first task type and the second task type to be executed, or processed. The arbitration method of the example shown in FIG. 5 may additionally perform a “lookahead” wherein in step 501 the processing resource is additionally operable to determine, or identify, if there are tasks of both the first task type and the second task type to be executed in the (near) future. Lookahead schemes are described in more detail further below.

If the determination at step 501 is “Yes”, the processing resource, in step 502, restricts the capacity of one or more of the subset of programmable execution units to process tasks of the first task type by reserving a proportion of the queue associated with one or more of the subset of programmable execution units for queueing only task(s) of the second task type. Thus, in step 502, tasks of the first task type are allocated to any programmable execution units in accordance with a queue limit applied to the queue associated with the programmable execution unit, and allocating any current task(s) of the second task type, or subsequent future task(s) of the second task type, to one or more of the reserved proportion of a queue associated with one or more programmable execution units of the subset of the programmable execution units.

If the determination at step 501 is “No”, the processing resource determines if there are any task(s) of the first task type in step 503 and, if so, in step 504 the processing resource allocates the task(s) of the first task type to any one or more of the programmable execution units. If the processing resource determines in step 503 that there are no task(s) of the first task type, the processing resource determines if there are any task(s) of the second task type in step 505 and, if so, in step 506 the processing resource allocates the task(s) of the second task type to one or more of the subset of programmable execution units.

Additionally or alternatively, in embodiments the restriction of the capacity of one or more of the subset of programmable execution units may be implemented by instructing the initiator not to allocate any further task(s), either completely e.g. halt the allocation of all tasks, or partially in that tasks of the first task type are not allocated to one or more of the subset of programmable execution units, thereby allowing any existing task(s) of the first task type to be completed enabling the one or more of the subset of programmable execution units to subsequently be allocated and/or process the task(s) of the second task type.

Additionally or alternatively, in embodiments the restriction of the capacity of one or more of the subset of programmable execution units may be implemented by cancelling one or more tasks of the first task type from a queue associated with one or more of the subset of programmable execution units when tasks of the second task type are currently, or will be in the (near) future due for execution, or processing, in combination with task(s) of the first task type. In order to prevent any potential loss of data or inconsistencies in the graphics processor, it may be beneficial to only cancel task(s) of the first task type that are present in the queue, but the execution, or processing, of those tasks has not yet started on the respective programmable execution unit. Thus, a cancellation request of a task that is being executed, or processed, by the respective programmable execution unit, may be discarded.

In embodiments, the processing resource may determine whether a queue for one or more of the programmable execution units of the subset of programmable execution units exceeds a predetermined threshold of a number of tasks of the first task type. If the threshold is exceeded then the processing resource may transmit a cancellation request message to one or more of the programmable execution units that exceed the predetermined threshold.

In embodiments, the cancellation of tasks of the first task type from a queue of one or more of the subset of programmable execution units may include the processing resource transmitting a cancellation request message to cancel one or more tasks of the first task type from a queue of one or more of the subset of programmable execution units. The processing resource may receive a confirmation message, or an indication, that the requested cancellation of a task of the first task type from a queue of one or more of the subset of programmable execution units has been performed. In response to receiving the confirmation message, or indication, the processing resource may then subsequently reissue, or reallocate, the cancelled task to another programmable execution unit, for example, a programmable execution unit that is not currently, or in the (near) future going to execute, or process, a task of the second task type.

FIG. 6 shows a flowchart of an arbitration scheme according to one or more embodiments, that implements the restriction in capacity by cancelling one or more tasks of a first task type from a queue associated with one or more of the subset of programmable execution units which are to execute, or process, task(s) of the second task type.

In step 601, the processing resource is operable to determine if there are task(s) of both the first task type and the second task type to be executed, or processed. The arbitration method of the example shown in FIG. 6 may additionally perform a “lookahead” wherein in step 601 the processing resource is additionally operable to determine, or identify, if there are tasks of both the first task type and the second task type to be executed in the (near) future.

If the determination at step 601 is “Yes”, the processing resource restricts the capacity of one or more of the subset of programmable execution units to process tasks of the first task type by cancelling one or more tasks of the first task type from a queue associated with one or more of the subset of programmable execution units, in step 602. In step 602, it may further be determined whether a queue of one or more of the subset of programmable execution units includes a number of tasks of the first task type that exceeds a predetermined threshold. If so, a cancellation request message may be transmitted to the respective programmable execution unit(s) of the subset of programmable execution units in order to cancel one or more tasks of the first task type from the queue of the respective programmable execution unit(s) of the subset of programmable execution units.

Tasks of the first task type may be allocated to any programmable execution units (except to any of the subset of programmable execution units from which tasks of the first task type have been cancelled), and any current task(s) of the second task type, or subsequent future task(s) of the second task type, may be allocated to one or more of the subset of the programmable execution units and, in the case that tasks of the first task type have been cancelled from one or more of the subset of programmable execution units, to those programmable execution units.

If the determination at step 601 is “No”, the processing resource determines if there are any task(s) of the first task type in step 603 and, if so, in step 604 the processing resource allocates the task(s) of the first task type to any one or more of the programmable execution units. If the processing resource determines in step 603 that there are no task(s) of the first task type, the processing resource determines if there are any task(s) of the second task type in step 605 and, if so, in step 606 the processing resource allocates the task(s) of the second task type to one or more of the subset of programmable execution units.

Alternatively, or additionally, any tasks of the first task type that are currently being executed, or processed, may, in fact, be suspended and subsequently resumed. Thus, tasks of the first task type that are currently in progress (e.g. currently being executed or processed) can be suspended by the respective programmable execution unit, wherein during suspension the data relating to the suspended task of the first task type can be temporarily stored in a memory allowing for later resumption by the programmable execution unit. Once the execution, or processing, of the task(s) of the second task type have been completed then the programmable execution unit can return to executing, or processing, the suspended tasks of the first task type. Thus, the processing resource may restrict a capacity of one or more of the subset of programmable execution units to process tasks of the first task type by issuing, or transmitting, a message (e.g. an instruction) to one or more of the subset of programmable execution units to suspend one or more tasks of the first task type.

Alternatively, or additionally, instead of cancelling tasks of the first task type that have not yet been executed, or processed, the processing resource may instruct one or more of the subset of programmable execution units to not process task(s) of the first task type currently in a queue associated with the one or more of the subset of programmable execution units, and to prioritise the execution, or processing of task(s) of the second task type. The programmable execution unit may therefore process tasks of the second task type ahead of the task(s) of the first task type. In other words, the task(s) of the second task type effectively “jump the queue” of task(s) of the first task type that are ahead of the task(s) of the second task type in the queue but, instead of cancelling the task(s) of the first task type from the queue associated with the one or more of the subset of programmable execution units, they remain in the queue to be processed, or executed, once the task(s) of the second task type have been completed. Thus, the processing resource may restrict a capacity of one or more of the subset of programmable execution units to process tasks of the first task type by issuing, or transmitting, a message (e.g. an instruction) to one or more of the subset of programmable execution units to not process, or execute, one or more tasks of the first task type.

In the above-described embodiments and examples, restricting a capacity of one or more of the subset of programmable execution units (e.g. shader cores) to process tasks of the first task type may refer to restricting an ability of the one or more of the subset of programmable execution units (e.g. shader cores) to process tasks of the first task type, or to enable one or more of the subset of programmable execution units (e.g. shader cores) to prioritise the processing of tasks of the second task type.

In the above-described embodiments and examples, two different task types were described, being “standard” graphics processing operations as a first task type and a single “specialised” processing operations as a second task type. For example, such “standard” graphics processing operations of the first task type may include one or more of a graphics compute shader task, a vertex shader task, a fragment shader takes, a tessellation shader task, and a geometry shader task, and so on, and the single “specialised” processing operation may include one of Neural operations, ray-tracing operations, distributed binning operations, motion estimation, and so on. However, as will be appreciated there may be any number of different task types, each for a different “specialised” operation, and as such there may be any number of subsets of programmable execution units that may include the functionality to execute, or process, any number of the different task types.

For example, with reference to FIG. 1B, programmable execution unit (e.g. shader core) 150a may include a processing module for processing task(s) relating to standard graphics processing operations, programmable execution unit (e.g. shader core) 150b may include a processing module for processing task(s) relating to standard graphics processing operations and a processing module for processing task(s) relating to the specialised operation of ray-tracing operations, programmable execution unit (e.g. shader core) 150c may include a processing module for processing task(s) relating to standard graphics processing operations, a processing module for processing task(s) relating to the specialised operation of neural operations, and a processing module for processing task(s) relating to the specialised operation of distributed binning operations, and programmable execution unit (e.g. shader core) 150d may include a processing module for processing task(s) relating to standard graphics processing operations, a processing module for processing task(s) relating to the specialised operation of neural operations, a processing module for processing task(s) relating to the specialised operation of distributed binning operations, and a processing module for processing task(s) relating to the specialised operation of ray-tracing operations. Thus, in this example, the four programmable execution units 150a, 150b, 150c, and 150d may be assigned to different subsets of programmable execution units that are operable to execute, or process, task(s) relating to one or more of the four different task types mentioned above. Each of the arbitration methods described in relation to FIGS. 2 to 6 can be extended to cover embodiments in which there are any number of different task types and different subsets of programmable execution units.

In the embodiments and examples described in relation to FIGS. 2 to 6, a restriction in capacity of one or more of the subset of programmable execution units to process tasks of the first task type is applied when there are tasks of both the first task type and the second task type to be executed, pr processed. Thus, when there are only tasks of one of the first task type or the second task type to be executed, or processed, then either no restrictions in capacity are implemented, or any previously implemented restrictions in capacity are removed.

As discussed hereinabove, the embodiments and examples described in relation to FIGS. 2 to 6 are not mutually exclusive but can be, and in embodiments are, combinable in any combination. For example, the arbitration method to restrict the capacity of one or more of a subset of programmable execution units by reserving a proportion of the subset of programmable execution units can be combined with the arbitration method to restrict the capacity of limiting a queue of one or more of a subset of programmable execution units.

In the embodiments and examples described in relation to FIGS. 2 to 6, the processing resource may optionally perform a “lookahead” wherein the processing resource is additionally operable to determine, or identify, if there are tasks of both the first task type and the second task type (or any further different task type as required) to be executed in the (near) future. This may be achieved in a number of ways.

For example, the host processor may transmit, or provide, to the processing resource an indication that a command requiring the execution, or processing, of one or more specialised task types is, will be, or has been, written to the command (stream) buffer, for example, stored in memory, that the processing resource will subsequently obtain (or read, or fetch), from the buffer (e.g. stored in memory) to execute. The indication may additionally include information, or parameters, relating to the command, for example, an indication of the amount of processing that may be required to execute the command.

Alternatively, or additionally, the processing resource may obtain in advance (e.g. pre-fetch) one or more commands (or one or more command streams), for example, from memory, and analyse the commands in advance of executing the commands on the graphics processor, in order to identify (near) future tasks of both the first task type and the second task type. For example, the one or more commands obtained in advance may relate to a subsequent frame thereby enabling the processing resource to have visibility of all the commands currently being processed for the current frame and all the commands relating to the next frame that will be processed in the (near) future.

Alternatively, or additionally, the processing resource will have visibility of the current jobs from of each job type and may also have visibility of the next job(s). A job for example might be decomposed into, for example, 256 tasks, where each task may require a reasonable amount of processing/time. Each task may then be issued to each programmable execution unit (e.g. shader core) by the iterator. If there are, for example, 10 programmable execution units, and each programmable execution unit can accept two tasks for a given job type, then 10×2=20 tasks are issued to the programmable execution units immediately. When one of the tasks completes in a programmable execution unit, a further task can be issued to the programmable execution unit. The processing resource can keep track of the size of a job, the number of tasks completed, the number of tasks processing, and the number of tasks left. Therefore, if another job type (including tasks of a specialised task type) are present then the processing resource has time to identify at tasks being currently processed and to modify the behaviour, e.g. restrict the capacity of one or more of the subset of programmable execution units, as necessary (e.g. where to submit tasks from the currently running job).

Alternatively, or additionally, the processing resource may include a scoreboard 195, which is typically used to independently track the processing job completion for each command (stream) 120. The scoreboard 195 is thus a shared resource. The scoreboard 195 tracks the progress of the processing tasks associated with each processing job. The scoreboard may be implemented as a counter that can be appropriately incremented and decremented to track the progress of a producer process of a task associated with a consumer process task. The producer task provides, as output, an input to the consumer process task. For example, the producer process may increment the associated scoreboard counter to indicate that the producer process has completed the particular task. The consumer process monitors the associated scoreboard counter and waits for the associated scoreboard counter to become non-zero for the producer process task, indicating that the producer process has completed, and enabling the consumer process task to be executed. The consumer process will decrement the scoreboard counter and execute the consumer process task. If the consumer task is a task of the second task type, e.g. a specialised task type, then the processing resource 140 can advantageously utilise the scoreboard (e.g. the scoreboard counters) in order to determine, or identify, in advance a consumer process task relating to a specialised task type, e.g. the second task type, that will, in the (near) future, need to be executed, or processed, by a programmable execution unit of the subset of programmable execution units once the associated producer process task has completed. For example, the processing resource may monitor the scoreboard to determine, or identify, consumer tasks of a specialised task type that are awaiting for a scoreboard counter to be non-zero, thereby enabling the processing resource to lookahead and identify a specialised task type that will need to be executed in advance alongside tasks of the first task type, and to implement the restriction of capacity of one or more of the subset of programmable execution units to process tasks of the first task type according to one or more of the arbitration methods described herein, in advance of the consumer process task of the second task type being available to be executed, or processed.

The technology described herein is in an embodiment implemented in a data processing system that may include, for example, one or more processors, such as the graphics processor, a display controller (display processor), a video processor, etc., that may operate in the manner of the technology described herein, together with a host processor (CPU) and a memory or memories.

The various functions of the technology described herein can be carried out in any desired and suitable manner. For example, the functions of the technology described herein can be implemented in hardware or software, as desired. Thus, for example, the various functional elements, stages, units, and “means” of the technology described herein may comprise a suitable processor or processors, controller or controllers, functional units, circuitry, circuits, processing logic, microprocessor arrangements, etc., that are operable to perform the various functions, etc., such as appropriately dedicated hardware elements (processing circuits/circuitry) and/or programmable hardware elements (processing circuits/circuitry) that can be programmed to operate in the desired manner.

The foregoing detailed description has been presented for the purposes of illustration and description. It is not intended to be exhaustive or to limit the technology described herein to the precise form disclosed. Many modifications and variations are possible in the light of the above teaching. The described embodiments were chosen in order to best explain the principles of the technology described herein and its practical applications, to thereby enable others skilled in the art to best utilise the technology described herein, in various embodiments and with various modifications as are suited to the particular use contemplated. It is intended that the scope be defined by the claims appended hereto.

What is claimed is:

1. A graphics processor comprising:
a plurality of programmable execution units operable to process tasks of a first task type;
a subset of the plurality of programmable execution units further operable to process tasks of a second task type, wherein the second task type is different to the first task type; and
one or more processing resources, wherein each processing resource is operable to obtain one or more commands, and to decompose each command of the one or more commands into one or more tasks of the first task type or the second task type to be allocated between the plurality of programmable execution units;
wherein the processing resource is further operable to:
determine the tasks to be allocated include both the first task type and the second task type; and
based on the determination, restrict a capacity of one or more of the subset of programmable execution units to process tasks of the first task type.

2. The graphics processor of claim 1, in which the processing resource further comprises, or is operatively connected to, one or more iterators, and the processing resource is further operable to:
decompose each command into one or more jobs; and
allocate each job to an iterator;
wherein each iterator is operable to:
decompose each job into the one or more tasks of a first task type or a second task type; and
allocate each task between the plurality of programmable execution units.

3. The graphics processor of claim 1, in which the processing resource is further operable to:
restrict the capacity of one or more of the subset of programmable execution units by allocating tasks of the first task type to programmable execution units that are not part of the subset of the programmable execution units; and
allocating current tasks of the second task type to one or more of the subset of the programmable execution units.

4. The graphics processor of claim 1, in which each programmable execution unit includes a queue, wherein the queue queues task(s) allocated to the programmable execution unit, and the processing resource is further operable to:
restrict the capacity of one or more of the subset of programmable execution units by reducing a queue limit for the queue associated with the one or more of the subset of programmable execution units.

5. The graphics processor of claim 4, in which the processing resource is further operable to reduce the queue limit by a value, wherein the value is a static value or a dynamically determined value.

6. The graphics processor of claim 1, in which the processing resource is further operable to:
restrict the capacity of one or more of the subset of programmable execution units by reserving a proportion of the one or more of the subset of programmable execution units for only processing tasks of the second task type.

7. The graphics processor of claim 1, in which the processing resource is further operable to:
restrict the capacity of one or more of the subset of programmable execution units by reserving a proportion of a queue associated with the one or more of the subset of programmable execution units for queueing tasks of the second task type, wherein the queue queues tasks allocated to the associated one or more of the subset of programmable execution units.

8. The graphics processor of claim 1, in which the processing resource is further operable to:
restrict the capacity of one or more of the subset of programmable execution units by not allocating further tasks, or further tasks of the first task type, to one or more of the subset of programmable execution units.

9. The graphics processor of claim 1, in which the processing resource is further operable to:
restrict the capacity of one or more of the subset of programmable execution units by transmitting a cancellation message to cancel one or more tasks of the first task type from a queue associated with one or more of the subset of programmable execution units.

10. The graphics processor of claim 9, in which the processing resource is further operable to:
determine whether a queue for one or more of the programmable execution units of the subset of programmable execution units exceeds a predetermined threshold of a number of tasks of the first task type; and
if the determination indicates that the threshold is exceeded, transmit a cancellation request message to one or more of the programmable execution units that exceed the predetermined threshold.

11. The graphics processor of claim 9, in which the processing resource is further operable to:
reallocate the cancelled task to another programmable execution unit.

12. The graphics processor of claim 1, in which the processing resource is further operable to:
determine the tasks to be allocated include both the first task type and the second task type in advance of the task of the second task type being allocated to a programmable execution unit of the subset of programmable execution units.

13. The graphics processor of claim 12, in which the processing resource further comprises one or more scoreboards, wherein each scoreboard tracks a progress of a producer process task, wherein the producer process task is associated with a consumer process task and provides, as output, the input to the consumer process task, and wherein the consumer process task is a task of the second task type;
the processing resource is further operable to:
monitor the one or more scoreboards to identify a consumer process task of the second task type awaiting a completion of the associated producer process task; and
in advance of allocating the consumer process task of the second task type, restricting the capacity of one or more of the subset of programmable execution units to process tasks of the first task type.

14. The graphics processor of claim 13, in which the scoreboard includes a counter for each producer process task and associated consumer process task, wherein the processing resource is further operable to monitor for a counter of the producer process task associated with the consumer process task being non-zero.

15. The graphics processor of claim 12, in which the processing resource is further operable to:
obtain one or more commands in advance of executing the one or more commands;
analyse the commands in the obtained one or more commands to identify future tasks of the first task type and the second task type; and
in advance of allocating the future tasks of the second task type, restricting the capacity of one or more of the subset of programmable execution units to process tasks of the first task type.

16. The graphics processor of claim 1, in which the processing resource is further operable to:
restrict the capacity of one or more of the subset of programmable execution units by transmitting a suspend message to suspend one or more tasks of the first task type that are currently being processed by the one or more of the subset of programmable execution units.

17. The graphics processor of claim 16, in which the processing resource is further operable to:
transmit a resume message to the one or more of the subset of programmable execution units to resume a task of the one or more tasks of the first task type that were suspended.

18. The graphics processor of claim 1, in which the processing resource is further operable to:
restrict the capacity of one or more of the subset of programmable execution units by transmitting a message to instruct one or more of the subset of programmable execution units to not process one or more tasks of the first task type that are currently in a queue associated with the one or more of the subset of programmable execution units.

19. A method of operating a graphics processor, wherein the graphics processor comprises:
a plurality of programmable execution units operable to process tasks of a first task type;
a subset of the plurality of programmable execution units further operable to process tasks of a second task type, wherein the second task type is different to the first task type; and
one or more processing resource;
the method comprising:
obtaining, by a processing resource, one or more commands;
decomposing each command of the one or more obtained commands into one or more tasks of the first task type or the second task type to be allocated between the plurality of programmable execution units;
determining the tasks to be allocated include both the first task type and the second task type; and
restricting a capacity of one or more of the subset of programmable execution units to process tasks of the first task type.

20. A data processing system comprising:
a host processor,
a memory coupled to the host processor; and
one or more graphics processors coupled to the host processor via a bus, at least one of the one or more graphic processors comprising:
a plurality of programmable execution units operable to process tasks of a first task type;
a subset of the plurality of programmable execution units further operable to process tasks of a second task type, wherein the second task type is different to the first task type; and
one or more processing resources, wherein each processing resource is operable to obtain one or more commands, and to decompose each command of the one or more commands into one or more tasks of the first task type or the second task type to be allocated between the plurality of programmable execution units;
wherein the processing resource is further operable to:
determine the tasks to be allocated include both the first task type and the second task type; and
based on the determination, restrict a capacity of one or more of the subset of programmable execution units to process tasks of the first task type.
